(19) United States
(12) Patent Application Publication
(10) Pub. No.: US 2009/0161758 A1
(43) Pub. Date: Jun. 25, 2009

(54) CODE AMOUNT CONTROL METHOD, CODE AMOUNT CONTROL DEVICE, AND CAMERA SYSTEM

(76) Inventors: Yoshihisa SHIMAZU, Kyoto (JP); Shinji Kitamura, Kyoto (JP)

Correspondence Address: MCDERMOTT WILL & EMERY LLP, 600 13TH STREET, NW, WASHINGTON, DC, 20005-3096, US

(21) Appl. No.: 12/332,818

(22) Filed: Dec. 11, 2008

(30) Foreign Application Priority Data
Dec. 20, 2007 (JP) JP 2007-329212

(51) Int. Cl. H04N 7/26

(52) U.S. Cl. 375/240.03; 375/E07.14

(57) ABSTRACT

The code amount in first video data is counted. The difference between the counted code amount and a predetermined code amount is summed. A target code amount for second video data to be encoded after the first video data is corrected based on the accumulated sum. An evaluation function for the second video data is selected based on the calculation of the motion vector of the second video data. The process calculates a first value based on a first quantization parameter for the first video data, the selected evaluation function and the counted code amount, and a second value based on a second quantization parameter for the second video data, the selected evaluation function and the corrected target code amount, and determines the second quantization parameter so that a difference between the first value and the second value is less than or equal to a predetermined amount.

### CROSS REFERENCE TO RELATED APPLICATION

This application claims priority under 35 U.S.C. §119 on Patent Application No. 2007-329212 filed in Japan on Dec. 20, 2007, the entire contents of which are hereby incorporated by reference.

### BACKGROUND OF THE INVENTION

The present invention relates to a method and device for controlling the amount of code generated (hereinafter referred to simply as the “code amount”) in a video encoding device for encoding video data and, more particularly, to a technique for controlling the code amount by adjusting the quantization parameter.

Signal processing techniques for compressing image data with a high compression rate have been developed in the art, and such signal processing techniques are used in digital cameras, digital video cameras, network cameras, etc. MPEG (Moving Picture Experts Group) is commonly known as a method for compressing video data. MPEG uses a motion detection operation for calculating a motion vector representing the displacement of the object by using a calculation method such as a block matching method, and uses a motion compensation operation for outputting block data, among all the reference image data, that is present at a position shifted by an amount of movement represented by the motion vector, as predictive block data. The process calculates the difference data between the predictive block data obtained by the motion compensation operation and macroblocks of video data, and performs an orthogonal transformation operation and a quantization operation on the calculation results, after which the process encodes the quantized video data and the motion vector obtained by the motion detection operation, thus efficiently compressing/encoding video data.

When encoding video data, it is preferred to maintain a desirable encoding rate. A method for optimizing the encoding rate is called “2-pass encoding”. The 2-pass encoding process first analyzes characteristics of video data while encoding the video data, and then decodes the encoded video data. Then, encoding parameters are optimized based on the results of the video data analysis, and the video data is encoded again. However, when processing video data in real time, there is only a limited amount of time that can be used for the encoding process, and it is difficult to use 2-pass encoding. In a network camera application, for example, there is a delay for transmitting/receiving data via a network, and there is therefore a demand for increasing the response speed (i.e., shortening the amount of time from the input of video data to the output of encoded data). Thus, a process called “1-pass encoding” is often used in the prior art.

A code amount controlling method commonly known in the art is to control the code amount by adjusting the quantization parameter. Referring to FIG. 13, the code amount decreases as the quantization parameter increases. In this method, when the code amount (i.e., the code amount as a result of encoding the current frame) is greater than the target code amount, the quantization parameter for the next frame is increased to thereby decrease the code amount in the next frame, and vice versa. Thus, the difference between the target code amount and the code amount can be brought closer to “0”.

Japanese Laid-Open Patent Publication No. 2006-109420 (Patent Document 1) discloses a method for controlling the quantization parameter so that the product between the code amount and the quantization parameter stays constant. Specifically, the quantization parameter for the next frame is determined so that the product between the target code amount and the quantization parameter for the next frame is equal to the product between the code amount of the current frame and the quantization parameter for the current frame. In Patent Document 1, the formula for calculating the quantization scale is changed when encoding an inter-encoding frame immediately after encoding an intra-encoding frame. This makes it possible to suppress variations of the quantization parameter.

However, it becomes more difficult to suppress the code amount as the quantization parameter decreases. For example, referring to FIG. 13, the gradient of the curve increases (i.e., the amount of increase in the code amount with respect to the increase in the quantization parameter increases) as the quantization parameter decreases. In other words, where the quantization parameter is small, the code amount varies significantly in response to a small change in the quantization parameter. Therefore, where the quantization parameter of the next frame corresponding to the target code amount is determined based on the code amount and the quantization parameter of the current frame so that the product between the code amount and the quantization parameter stays constant, the relationship between the product value (the product value between the code amount of the current frame and the quantization parameter of the current frame) and the quantization parameter of the current frame may become a downwardly-pointing curve as shown in FIG. 14. In such a case, two points may represent the same product value, whereby the calculation process may erroneously calculate an unintended quantization parameter.

Particularly, as the motion detection precision (the motion vector calculation precision) decreases, the degree of correlation between the input macroblock data and the predictive block data obtained by the motion compensation operation decreases, thus increasing the pixel value represented by the difference data being equal to the difference between the input macroblock data and the predictive macroblock data. Therefore, the code amount increases, thereby further increasing the possibility that the relationship between the product value and the quantization parameter becomes a downwardly-pointing curve.

### SUMMARY OF THE INVENTION

In view of the above, it is an object of the present invention to provide a method and device for controlling the amount of code generated in a video encoding device, wherein the erroneous calculation of the quantization parameter is suppressed.

According to one aspect of the present invention, a code amount controlling method is a method for controlling an amount of code generated in a video encoding device, the video encoding device including: a motion detection/compensation section for performing a motion detection/compensation operation on video data being whole or part of a video frame to thereby calculate a motion vector, and for outputting predictive data; an orthogonal transformation section for performing an orthogonal transformation on a difference between the video data and the predictive data; a quantization section for quantizing difference data, which has been transformed by the orthogonal transformation section, by using a quantization scale determined based on a quantization parameter; and an encoding section for encoding the difference data quantized by the quantization section and the motion vector calculated by the motion detection/compensation section, the code amount controlling method including the steps of: (a) counting an amount of code generated while first video data is encoded by the encoding section; (b) adding a difference between the code amount counted in the step (a) and a predetermined code amount to a sum of code amount differences; (c) correcting a target code amount for second video data to be encoded after the first video data, based on an accumulated sum calculated in the step (b); (d) selecting an evaluation function for the second video data, from among a plurality of evaluation functions each representing a relationship between the quantization parameter and an evaluation value, based on the calculation of the motion vector of the second video data by the motion detection/compensation section; and (e) calculating a first value based on a first quantization parameter for the first video data, the evaluation function selected in the step (d) and the code amount counted in the step (a), calculating a second value based on a second quantization parameter for the second video data, the evaluation function selected in the step (d) and the target code amount corrected in the step (c), and determining the second quantization parameter so that a difference between the first value and the second value is less than or equal to a predetermined amount.

In this code amount controlling method, by evaluating the quantization parameter by using an evaluation function selected based on the calculation of the motion vector, it is possible to reduce the influence of the code amount, and to suppress the erroneous calculation of the quantization parameter. Thus, it is possible to appropriately calculate the quantization parameter based on the motion vector calculation precision.

In the step (d), an evaluation function for the second video data may be selected, from among a plurality of evaluation functions each representing a relationship between the quantization parameter and an evaluation value, based on a first quantization parameter for the first video data.

In this code amount controlling method, by evaluating the quantization parameter by using an evaluation function that is selected based on a previously-used quantization parameter, it is possible to reduce the influence of the code amount and to suppress the erroneous calculation of the quantization parameter.

According to another aspect of the present invention, a code amount controlling device is a device for controlling an amount of code generated in a video encoding device, the video encoding device including: a motion detection/compensation section for performing a motion detection/compensation operation on video data being whole or part of a video frame to thereby calculate a motion vector; an orthogonal transformation section for performing an orthogonal transformation on the video data; a quantization section for quantizing video data, which has been transformed by the orthogonal transformation section, by using a quantization scale determined based on a quantization parameter; and an encoding section for encoding the video data quantized by the quantization section and the motion vector calculated by the motion detection/compensation section, the code amount controlling device including: a code amount counting section for counting an amount of code generated while video data is encoded by the encoding section, each time the encoding of the video data by the encoding section is completed; an SCD calculation section for summing a difference between the code amount counted by the code amount counting section and a predetermined code amount; a target code amount correction section for correcting a target code amount for video data to be encoded next, based on a sum of code amount differences calculated by the SCD calculation section; an evaluation function selecting section for selecting an evaluation function for the video data, from among a plurality of evaluation functions each representing a relationship between the quantization parameter and an evaluation value, based on the calculation of the motion vector of the video data by the motion detection/compensation section; and a quantization parameter determination section for determining a second quantization parameter so that a difference between a first value and a second value is less than or equal to a predetermined amount, wherein the first value is determined based on a quantization parameter for first video data, an evaluation function for second video data to be encoded after the first video data, and the code amount of the first video data, and the second value is determined based on a second quantization parameter for the second video data, the evaluation function for the second video data, and a target code amount for the second video data.

In this code amount controlling device, by evaluating the quantization parameter by using an evaluation function selected based on the calculation of the motion vector, it is possible to reduce the influence of the code amount, and to suppress the erroneous calculation of the quantization parameter. Thus, it is possible to appropriately calculate the quantization parameter based on the motion vector calculation precision.

### BRIEF DESCRIPTION OF THE DRAWINGS

FIG. 1 is a block diagram showing a configuration of a video encoding device according to Embodiment 1 of the present invention.

FIG. 2 is a block diagram showing a configuration of a code amount controlling section shown in FIG. 1.

FIG. 3 is a flow chart illustrating the operation of the code amount controlling section shown in FIG. 2.

FIG. 4 is a graph illustrating evaluation functions.

FIG. 5 is a graph illustrating the relationship between “target code amount × evaluation value” and the quantization scale.

FIG. 6 is a flow chart illustrating a variation of the operation of the code amount controlling section shown in FIG. 1.

FIG. 7 is a flow chart illustrating a first evaluation function selecting operation.

FIG. 8 is a flow chart illustrating a second evaluation function selecting operation.

FIG. 9 is a flow chart illustrating a third evaluation function selecting operation.

FIG. 10 is a flow chart illustrating the operation of a code amount controlling section according to Embodiment 2 of the present invention.

FIG. 11 is a block diagram showing a configuration of a camera system including the video encoding device shown in FIG. 1.

FIG. 12 is a diagram showing a case where the camera system shown in FIG. 11 is used as a network camera.

FIG. 13 is a graph showing the relationship between the quantization parameter and the code amount.

FIG. 14 is a graph showing the relationship between “quantization parameter × the code amount” and the quantization parameter.

### DESCRIPTION OF THE PREFERRED EMBODIMENTS

Embodiments of the present invention will now be described with reference to the drawings. Note that the present invention is not limited to the embodiments below.

### Embodiment 1

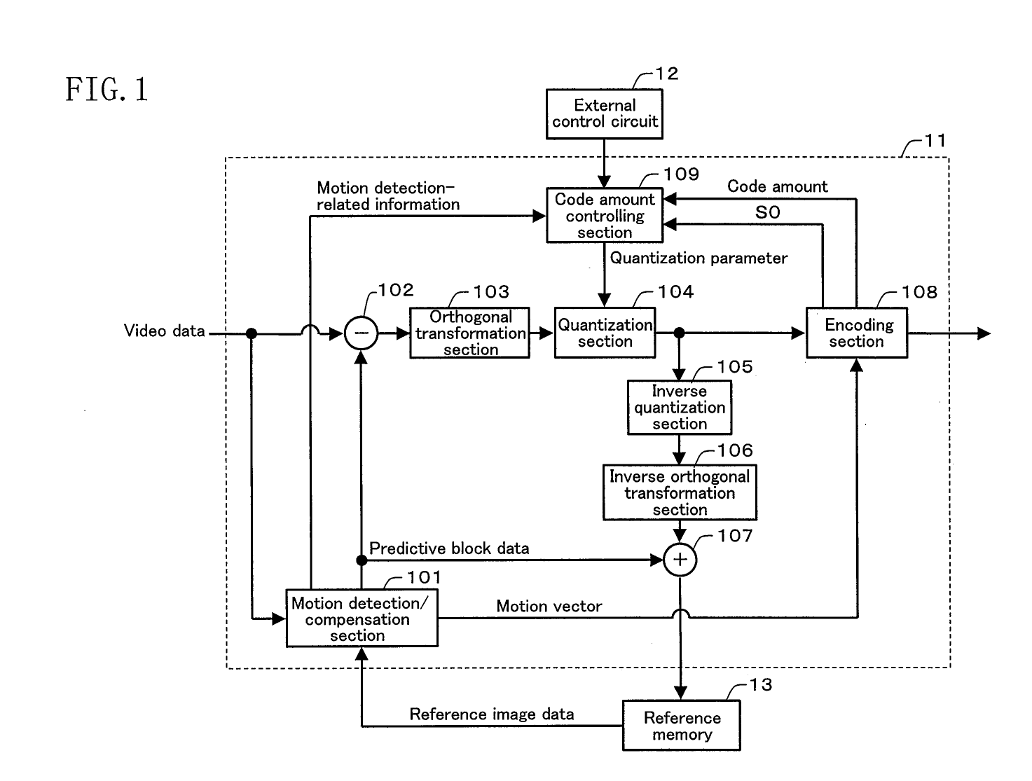

FIG. 1 shows a configuration of a video encoding device 11 according to Embodiment 1 of the present invention. The video encoding device 11 includes a motion detection/compensation section 101, a subtractor section 102, an orthogonal transformation section 103, a quantization section 104, an inverse quantization section 105, an inverse orthogonal transformation section 106, an adder section 107, an encoding section 108, and a code amount controlling section 109. The video encoding device 11 is connected to an external control circuit 12, and a reference memory 13 for storing reference image data.

The motion detection/compensation section 101 performs a motion detection operation by using input video data and reference image data stored in the reference memory 13 to calculate a motion vector. Specifically, video data is supplied in macroblocks to the video encoding device 11, and the motion detection/compensation section 101 detects the block data, from among the reference image data stored in the reference memory 13, that has the highest degree of correlation with the input block data, and calculates a motion vector that represents the amount of movement from the position of the input block data to the position of the detected block data. Moreover, the motion detection/compensation section 101 outputs the detected block data, as predictive block data, to the subtractor section 102 and the adder section 107 (motion compensation operation).

The subtractor section 102 calculates the difference between the input block data and the predictive block data from the motion detection/compensation section 101, and outputs the calculation result as predictive error block data.

The orthogonal transformation section 103 performs an orthogonal transformation on the predictive error block data.

The quantization section 104 determines the quantization scale based on the quantization parameter supplied from the code amount controlling section 109, and quantizes the block data, which has been orthogonally-transformed by the orthogonal transformation section 103, by using the determined quantization scale. The quantization scale can be represented as a function using the quantization parameter as an argument, and the quantization scale is uniquely determined if the quantization parameter is determined. For example, the value of the quantization scale linearly increases as the quantization parameter increases.

The inverse quantization section 105 inversely-quantizes the block data, which has been quantized by the quantization section 104.

The inverse orthogonal transformation section 106 performs an inverse orthogonal transformation on the block data, which has been inversely-quantized by the inverse quantization section 105.

The adder section 107 adds the predictive error block data from the motion detection/compensation section 101 to the block data, which has been subjected to the inverse orthogonal transformation by the inverse orthogonal transformation section 106, and outputs the operation result to the reference memory 13 as restored block data. The reference memory 13 stores the restored block data from the adder section 107, and produces reference image data using a plurality of restored block data.

The encoding section 108 converts the block data, which has been quantized by the quantization section 104, and the motion vector from the motion detection/compensation section 101 into a string of codes. The encoding section 108 outputs an encoding completion signal S0 to the code amount controlling section 109 as the encoding section 108 completes encoding of a predetermined processing unit.

Based on the encoding completion signal S0 from the encoding section 108, the code amount controlling section 109 counts the amount of code generated during the encoding of the predetermined processing unit by the encoding section 108. Moreover, the code amount controlling section 109 adjusts the quantization parameter for determining the quantization scale based on the counted code amount, control information from the external control circuit 12, etc. Thus, the code amount is controlled.

The processing unit as used herein refers to each of n areas of an equal size into which a video frame is divided. For example, where the processing unit is “frames”, the number of divisions n is at minimum (i.e., “1”), and where the processing unit is “macroblocks”, the number of divisions n is at maximum (i.e., the number of macroblocks per frame). While the processing unit is “frames” in the following description, the present invention is not limited thereto.

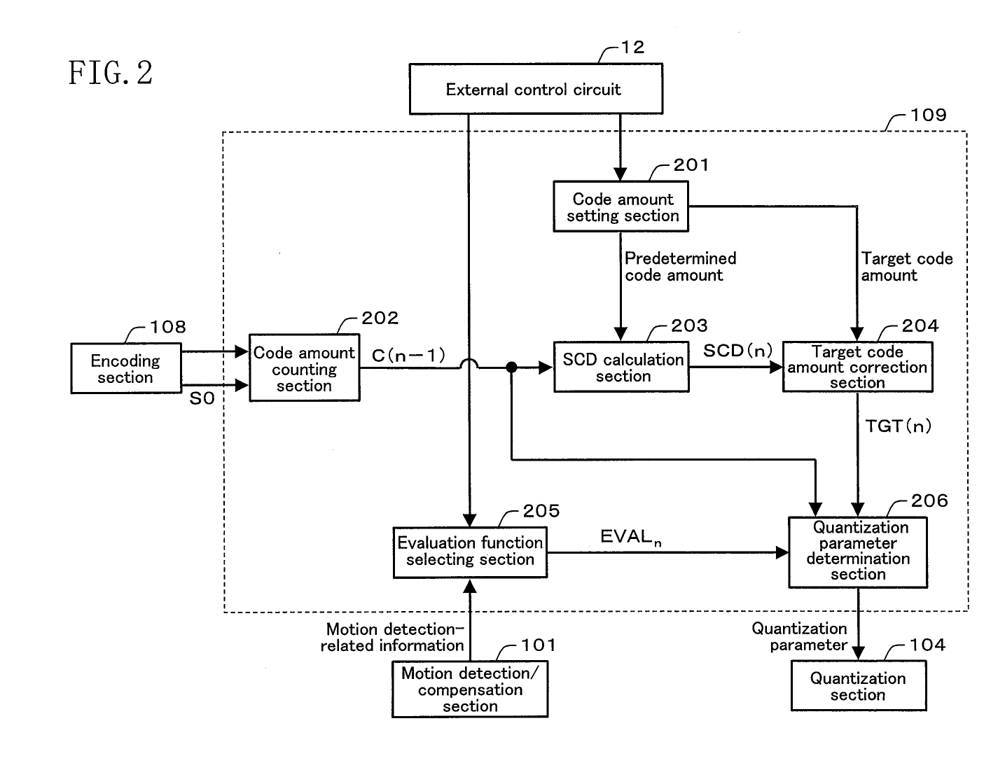

FIG. 2 shows an internal configuration of the code amount controlling section 109 shown in FIG. 1. The code amount controlling section 109 includes a code amount setting section 201, a code amount counting section 202, an SCD (sum of code amount differences) calculation section 203, a target code amount correction section 204, an evaluation function selecting section 205, and a quantization parameter determination section 206.

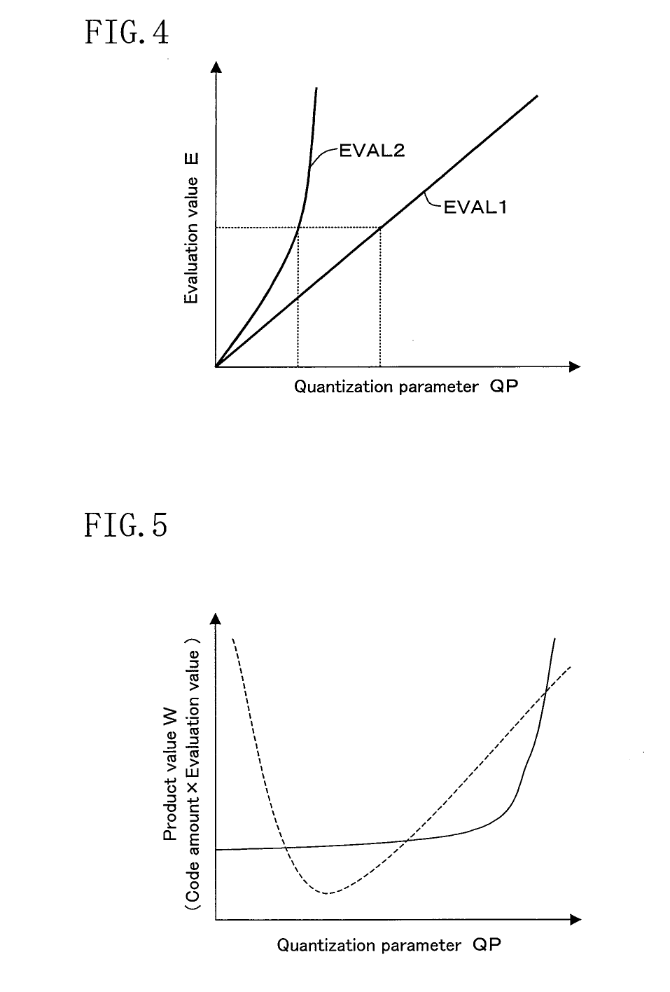

The code amount setting section 201 sets a predetermined code amount and a target code amount based on the control information (e.g., information relating to the bit rate) from the external control circuit 12. The code amount counting section 202 counts the code amount each time the encoding of the predetermined processing unit by the encoding section 108 is completed (each time the encoding completion signal S0 is output). The SCD calculation section 203 accumulates the difference between the code amount counted by the code amount counting section 202 and the predetermined code amount set by the code amount setting section 201. The target code amount correction section 204 corrects the target code amount set by the code amount setting section 201 based on the sum of code amount differences calculated by the SCD calculation section 203. The evaluation function selecting section 205 selects an evaluation function, from among a plurality of evaluation functions, based on information relating to the calculation of the motion vector by the motion detection/compensation section 101 (motion detection-related information). Each of the plurality of evaluation functions is a function using the quantization parameter as an argument, and represents the relationship between the quantization parameter and the evaluation value. The amount of increase in the evaluation value in response to an increase in the quantization parameter varies for each evaluation function. For example, referring to FIG. 4, an evaluation function EVAL1 is a straight line representing the evaluation value linearly increasing in response to an increase in the quantization parameter (i.e., similar to the quantization scale), and another evaluation function EVAL2 is a curve representing the evaluation value exponentially increasing in response to an increase in the quantization parameter. The quantization parameter determination section 206 performs the process of determining the quantization parameter when the encoding completion signal S0 becomes active or when a command to start the encoding process of the next frame is issued from the external control circuit 12.

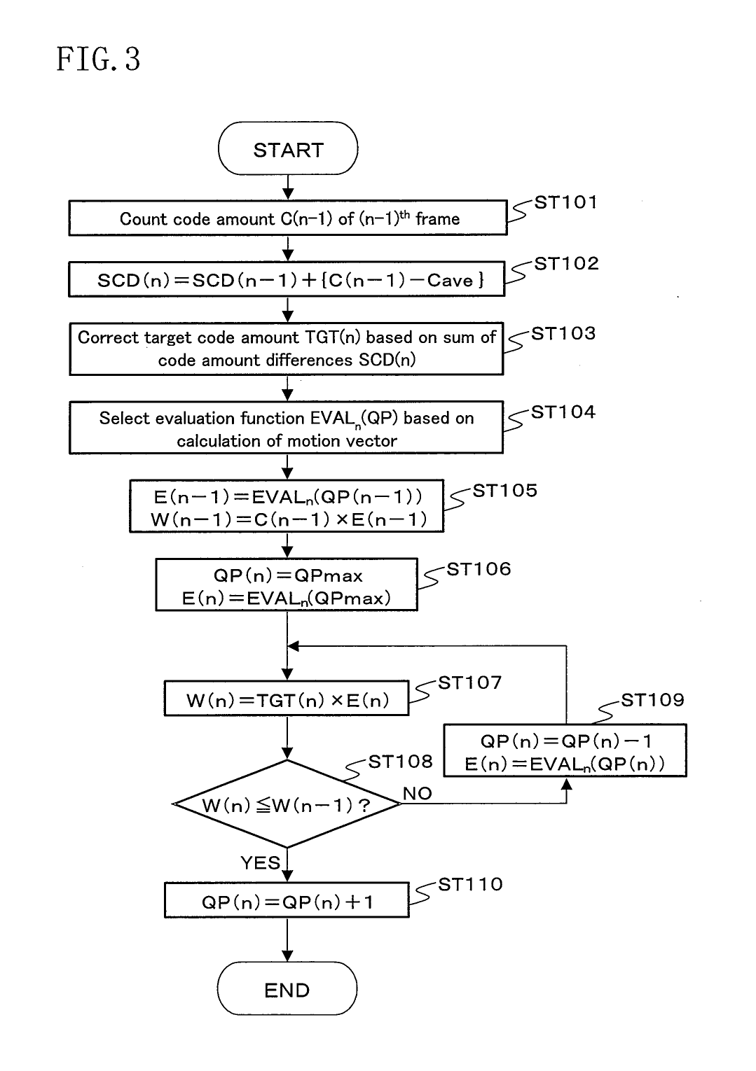

Next, referring to FIG. 3, an operation of the code amount controlling section 109 shown in FIG. 2 will be described. The following description is directed to an operation of determining the quantization parameter for the n^{th} frame.

Step ST101

First, the code amount counting section 202 starts counting the code amount when the encoding of the (n−1)^{th} frame is started, and outputs the counted code amount to the SCD calculation section 203 and the quantization parameter determination section 206 when the encoding of the (n−1)^{th} frame is completed. Thus, the code amount C(n−1) for the (n−1)^{th} frame is obtained.

Step ST102

Then, the SCD calculation section 203 calculates the difference between the code amount C(n−1) from the code amount counting section 202 and the predetermined code amount (herein the average code amount Cave per frame) set by the code amount setting section 201, and adds the calculated difference to the sum of code amount differences SCD(n−1). Thus, the sum of code amount differences SCD(n) for the n^{th} frame is calculated. The initial value of the sum of code amount differences SCD(n−1) (where n=1) is “0”. The sum of code amount differences SCD(n−1) may be initialized depending on the type of the video frame encoded. For example, the sum of code amount differences SCD(n−1) may be set to “0” when the n^{th} frame is an “I picture”.

Step ST103

Then, the target code amount correction section 204 corrects the target code amount TGT(n) for the n^{th} frame based on the sum of code amount differences SCD(n) calculated by the SCD calculation section 203. For example, the target code amount correction section 204 corrects the target code amount TGT(n) so that the target code amount TGT(n) is less than the average code amount Cave if the sum of code amount differences SCD represents a positive value, and corrects the target code amount so that the target code amount TGT(n) is greater than the average code amount Cave if the sum of code amount differences SCD(n) represents a negative value. Then, the target code amount correction section 204 outputs the corrected target code amount TGT(n) to the quantization parameter determination section 206. The target code amount TGT(n) may be obtained by subtracting the sum of code amount differences SCD(n) from the target code amount set by the code amount setting section 201 (e.g., the average code amount Cave). Alternatively, there may be an upper limit value and a lower limit value for the amount of correction to be made to the target code amount TGT(n), wherein it is ensured that the amount of correction made to the target code amount TGT(n) is kept within a predetermined range.

Step ST104

The motion detection/compensation section 101 performs a motion detection/compensation operation on the n^{th} frame to thereby calculate the motion vector of the n^{th} frame. The evaluation function selecting section 205 selects an evaluation function EVALₙ(QP) for the n^{th} frame, from among a plurality of evaluation functions, based on information relating to the calculation of the motion vector of the n^{th} frame by the motion detection/compensation section 101 (motion detection-related information). For example, for a lower motion vector calculation precision, the evaluation function selecting section 205 selects an evaluation function representing a greater increase in the evaluation value in response to the increase in the quantization parameter.

Step ST105

Then, the quantization parameter determination section 206 calculates the evaluation value E(n−1) of the (n−1)^{th} frame based on the evaluation function EVALₙ(QP) selected by the evaluation function selecting section 205 and the quantization parameter QP(n−1) for the (n−1)^{th} frame. The evaluation value E(n−1) can be expressed as follows.

E(n−1)=EVALₙ(QP(n−1))

Then, the quantization parameter determination section 206 calculates the product value W(n−1) between the calculated evaluation value E(n−1) and the code amount C(n−1) counted by the code amount counting section 202.

Step ST106

Then, the quantization parameter determination section 206 sets the initial value of the quantization parameter QP(n) for the n^{th} frame to the maximum value QPmax, and calculates the evaluation value E(n) of the n^{th} frame based on the quantization parameter QP(n) and the evaluation function EVALₙ(QP) selected by the evaluation function selecting section 205. The evaluation value E(n) can be expressed as follows.

E(n)=EVALₙ(QP(n))=EVALₙ(QPmax)

Step ST107

Then, the quantization parameter determination section 206 calculates the product value W(n) between the evaluation value E(n) and the target code amount TGT(n) from the target code amount correction section 204.

Step ST108

Then, the quantization parameter determination section 206 compares the product value W(n−1) and the product value W(n) with each other. If the product value W(n) for the n^{th} frame is greater than the product value W(n−1) for the (n−1)^{th} frame, the process proceeds to step ST109. Otherwise, the process proceeds to step ST110.

Step ST109

Then, the quantization parameter determination section 206 subtracts “1” from the quantization parameter QP(n) for the n^{th} frame, and re-calculates the evaluation value E(n) based on the evaluation function EVALₙ(QP) and the quantization parameter QP(n) after the subtraction. Then, the process proceeds to step ST107.

Step ST110

If, in step ST108, the product value W(n) is less than or equal to the product value W(n−1), the quantization parameter determination section 206 adds “1” to the quantization parameter QP(n), and outputs the quantization parameter QP(n) after the addition to the quantization section 104.

Referring to FIG. 4, if the motion vector calculation precision is low, for example, the evaluation function is switched from the evaluation function EVAL1 currently being selected to another evaluation function of which the influence of the code amount is smaller and the influence of the quantization scale is larger (herein, the evaluation function EVAL2 having a greater exponent), whereby the product value between the quantization parameter QP(n−1) and the code amount C(n−1) is not a downwardly-pointing curve as shown in FIG. 5. Thus, with the provision of an evaluation function such that the relationship between the product value (the product value between the code amount and the evaluation value) and the quantization parameter will not be a downwardly-pointing curve but will be a curve that rises from left to right, it is possible to prevent the relationship between the product value and the quantization parameter from being a downwardly-pointing curve. These evaluation functions can be associated with different degrees of motion vector calculation precision. For example, an evaluation function having a higher exponent may be selected for a lower motion vector calculation precision.

As described above, by evaluating the quantization parameter by using an evaluation function selected based on the calculation of the motion vector, it is possible to reduce the influence of the code amount, and to suppress the erroneous calculation of the quantization parameter. Thus, it is possible to appropriately calculate the quantization parameter based on the motion vector calculation precision.

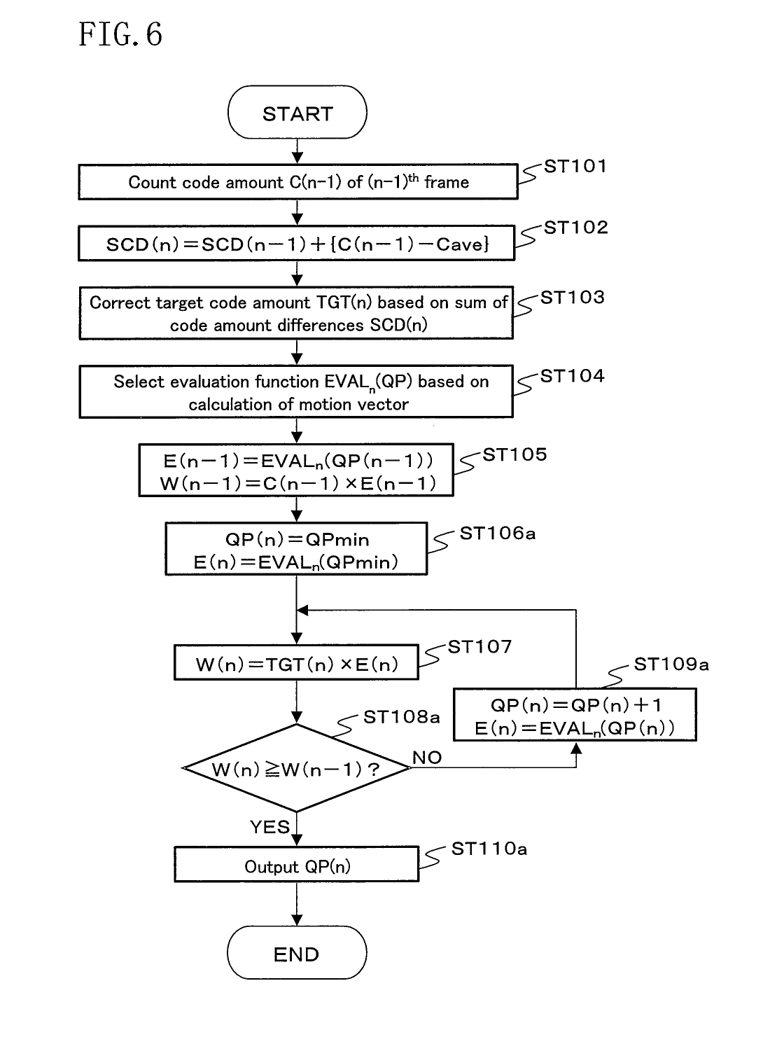

Referring to FIG. 6, the quantization parameter determination section 206 may set the initial value of the quantization parameter QP(n) to the minimum value QPmin (step ST106a). In such a case, the quantization parameter determination section 206 compares the product value W(n) and the product value W(n−1) with each other (step ST108a), and “1” is added to the quantization parameter QP(n) if the product value W(n) is less than the product value W(n−1) (step ST109a). If the product value W(n) is greater than or equal to the product value W(n−1), the quantization parameter determination section 206 outputs the quantization parameter QP(n) to the quantization section 104 (step ST110a).

Operation by Motion Detection/Compensation Section

Before describing the evaluation function selecting operation by the evaluation function selecting section 205, the operation by the motion detection/compensation section 101 will be described in detail.

First, the motion detection/compensation section 101 receives control information (the motion estimation range, the number of motion estimations, etc.) from the external control circuit 12.

Then, the motion detection/compensation section 101 receives a video frame in macroblocks. The motion detection/compensation section 101 selects, as a candidate block data, a block area from among the reference image data that has the same sizes as the input macroblock within the predetermined motion estimation range, and calculates the SAD value (the sum of absolute differences) between the pixel values included in the selected candidate block data and the average pixel value of the input macroblock data. Then, the motion detection/compensation section 101 moves the position of the block area within the motion estimation range to select the next candidate block data and calculate the SAD value for the candidate block data. Thus, the motion detection/compensation section 101 moves the position of the block area by the predetermined number of motion estimations (i.e., selects the same number of candidate block data as the number of motion estimations), and calculates the SAD value for each of the candidate block data.

Then, the motion detection/compensation section 101 calculates the motion vector of the input macroblock data based on the SAD value calculated for each candidate block data. For example, the motion detection/compensation section 101 outputs a motion vector that represents the smallest one of the SAD values.

Then, the motion detection/compensation section 101 receives the next macroblock data, and performs the operation as described above. Thus, the motion vector is calculated for each macroblock.

First Evaluation Function Selecting Operation

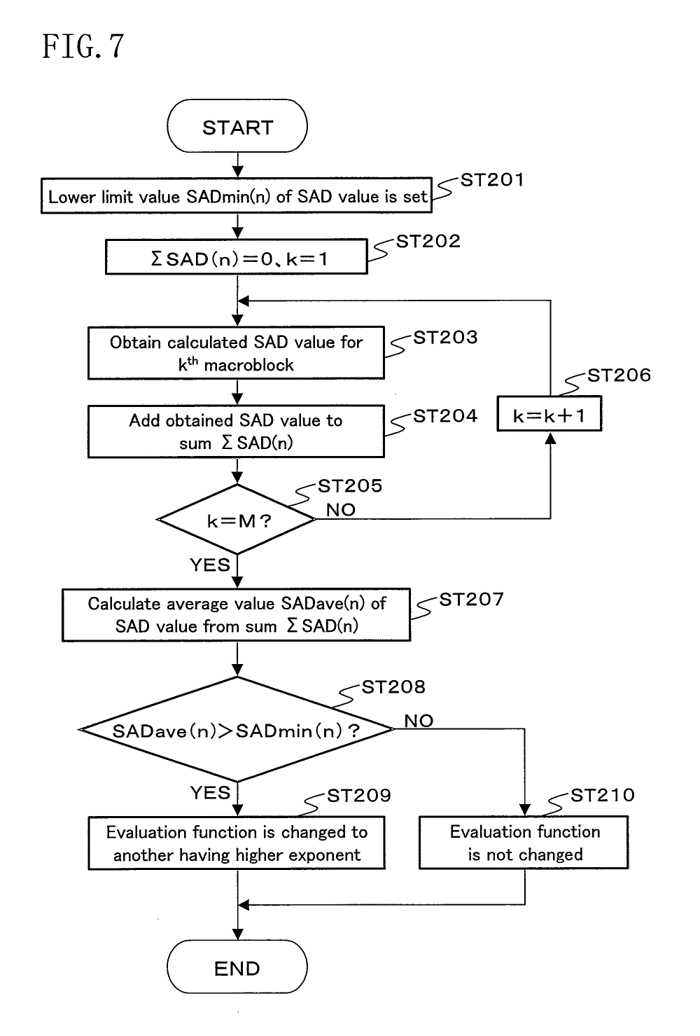

Then, referring to FIG. 7, a first evaluation function selecting operation by the evaluation function selecting section 205 will be described.

First, the external control circuit 12 sets the lower limit value SADmin(n) of the SAD value in the evaluation function selecting section 205 (step ST201). The lower limit value SADmin(n) is not limited to a fixed value, but may be a variable value that varies for each video frame.

Then, the evaluation function selecting section 205 sets the sum ΣSAD(n) of the SAD value for the n^{th} frame to “0”, and sets the subject macroblock number k to “1” (step ST202).

Then, the evaluation function selecting section 205 obtains the SAD value calculated by the motion detection/compensation section 101 for the k^{th} macroblock of the n^{th} frame (step ST203), and adds the obtained SAD value to the sum ΣSAD(n) (step ST204).

Then, the evaluation function selecting section 205 determines whether the subject macroblock number k has reached the number of macroblocks M (herein, the number of macroblocks per frame) (step ST205). If the subject macroblock number k has not reached the number of macroblocks M, the evaluation function selecting section 205 adds “1” to the subject macroblock number k (step ST206), and performs step ST203. If the subject macroblock number k has reached the number of macroblocks M, the evaluation function selecting section 205 divides the sum ΣSAD(n) of the SAD value by “M” to thereby calculate the average value SADave(n) of the SAD value for the n^{th} frame (step ST207).

Then, the evaluation function selecting section 205 compares the average value SADave(n) of the SAD value and the lower limit value SADmin(n) of the SAD value with each other (step ST208). If the average value SADave(n) of the SAD value is greater than the lower limit value SADmin(n) of the SAD value, the evaluation function selecting section 205 selects, as the evaluation function EVALₙ for the n^{th} frame, an evaluation function having a higher exponent than the evaluation function currently being selected (the evaluation function EVALₙ₋₁) (step ST209). If the average value SADave(n) of the SAD value is less than or equal to the lower limit value SADmin(n) of the SAD value, the evaluation function selecting section 205 selects, as the evaluation function EVALₙ for the n^{th} frame, the evaluation function currently being selected (the evaluation function EVALₙ₋₁ for the (n−1)^{th} frame) (step ST210).

While the number of macroblocks M is the number of macroblocks included per frame in the above description, it may be the number of macroblocks included per slice. Moreover, the number of macroblocks M may be “1” (i.e., the operation described above may be performed by macroblocks).

Second Evaluation Function Selecting Operation

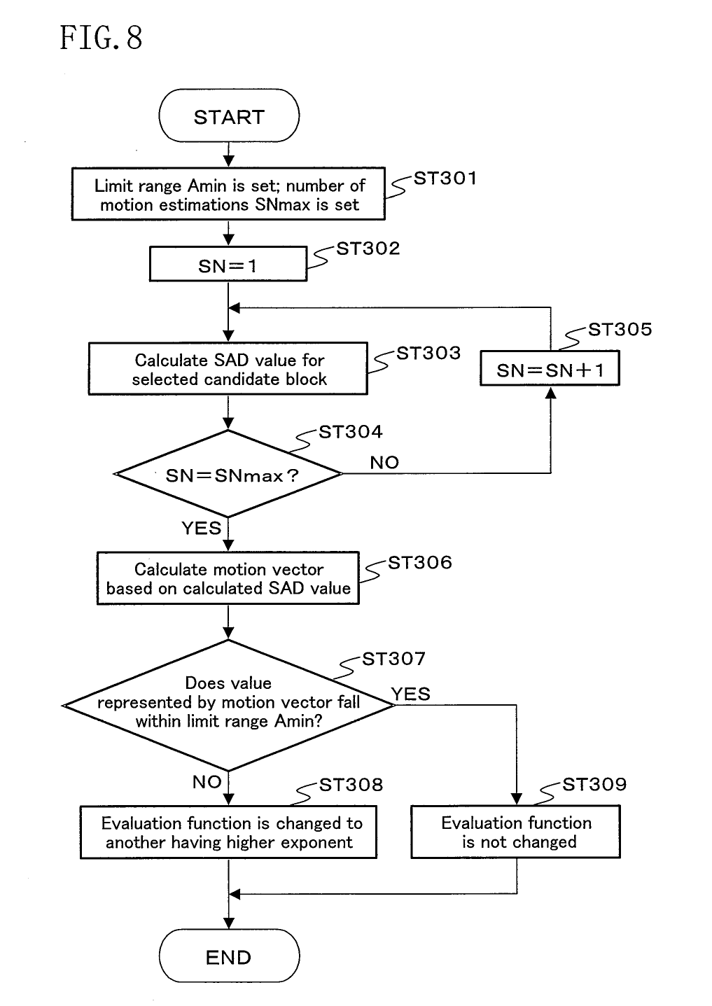

Then, referring to FIG. 8, a second evaluation function selecting operation by the evaluation function selecting section 205 will be described.

First, the external control circuit 12 sets the upper limit value SNmax of the number of motion estimations in the motion detection/compensation section 101, and sets the limit range Amin in the evaluation function selecting section 205 (step ST301). Herein, the limit range Amin represents the minimum area to be searched when calculating the motion vector by performing block matching in the motion detection/compensation.

Then, the motion detection/compensation section 101 sets the number of motion estimations SN to “1” (step ST302). Then, the motion detection/compensation section 101 receives a macroblock of the n^{th} frame. The motion detection/compensation section 101 selects, from among the reference image data, a candidate block to be used for the comparison with the input macroblock, and calculates the SAD value for the selected candidate block (step ST303).

Then, the motion detection/compensation section 101 determines whether the number of motion estimations SN has reached the upper limit value SNmax of the number of motion estimations (step ST304). If the number of motion estimations SN has not reached the upper limit value SNmax of the number of motion estimations, “1” is added to the number of motion estimations SN (step ST305), and the SAD value is calculated for the next candidate block. If the number of motion estimations SN has reached the upper limit value SNmax of the number of motion estimations, the motion detection/compensation section 101 calculates the motion vector based on the SAD value of each candidate block (step ST306).

Then, the evaluation function selecting section 205 obtains the motion vector calculated by the motion detection/compensation section 101, and determines whether the value represented by the motion vector falls within the limit range Amin (step ST307). If the value represented by the motion vector does not fall within the limit range Amin, the evaluation function selecting section 205 selects, as the evaluation function EVALₙ for the n^{th} frame, an evaluation function having a higher exponent than the evaluation function currently being selected (the evaluation function EVALₙ₋₁) (step ST308). If the value represented by the motion vector falls within the limit range Amin, the evaluation function selecting section 205 selects, as the evaluation function EVALn for the n^{th} frame, the evaluation function currently being selected (the evaluation function EVALₙ₋₁ for the (n−1)^{th} frame) (step ST309).

While the description above is directed to a case where the operation is performed for each macroblock, the operation may be performed for each frame. For example, in step ST307, after the motion vectors for one frame are calculated, the process may calculate the average value from these motion vectors, and then proceed to step ST307, wherein it is determined whether the average value thereof falls within the limit range Amin.

Third Evaluation Function Selecting Operation

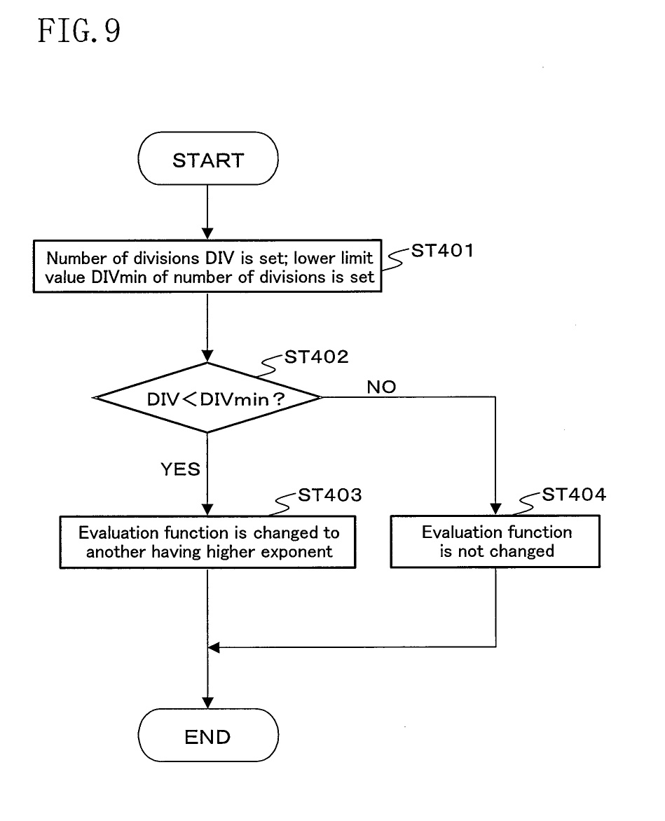

Then, referring to FIG. 9, a third evaluation function selecting operation by the evaluation function selecting section 205 will be described.

First, the external control circuit 12 sets the number of divisions DIV in the motion detection/compensation section 101, and sets the number of divisions DIV and the lower limit value DIVmin of the number of divisions in the evaluation function selecting section 205 (step ST401). After receiving macroblock data of the n^{th} frame, the motion detection/compensation section 101 divides the input macroblock based on the number of divisions DIV, and calculates the motion vector for each of the sub-blocks obtained by the division. For example, where the number of divisions DIV is 2ⁿ, 2ⁿ motion vectors are calculated for an input macroblock. In other words, the number of divisions is equivalent to the number of motion vectors, and the motion compensation precision will be higher as the number of divisions DIV is greater.

The evaluation function selecting section 205 compares the number of divisions DIV and the lower limit value DIVmin of the number of divisions with each other (step ST402). If the number of divisions DIV is less than the lower limit value DIVmin, the evaluation function selecting section 205 selects, as the evaluation function EVALₙ for the n^{th} frame, an evaluation function having a higher exponent than the evaluation function currently being selected (evaluation function EVALₙ₋₁) (step ST403). If the number of divisions DIV is greater than the lower limit value DIVmin, the evaluation function selecting section 205 selects, as the evaluation function EVALn for the n^{th} frame, the evaluation function currently being selected (the evaluation function EVALₙ₋₁ for the (n−1)^{th} frame) (step ST404).

### Embodiment 2

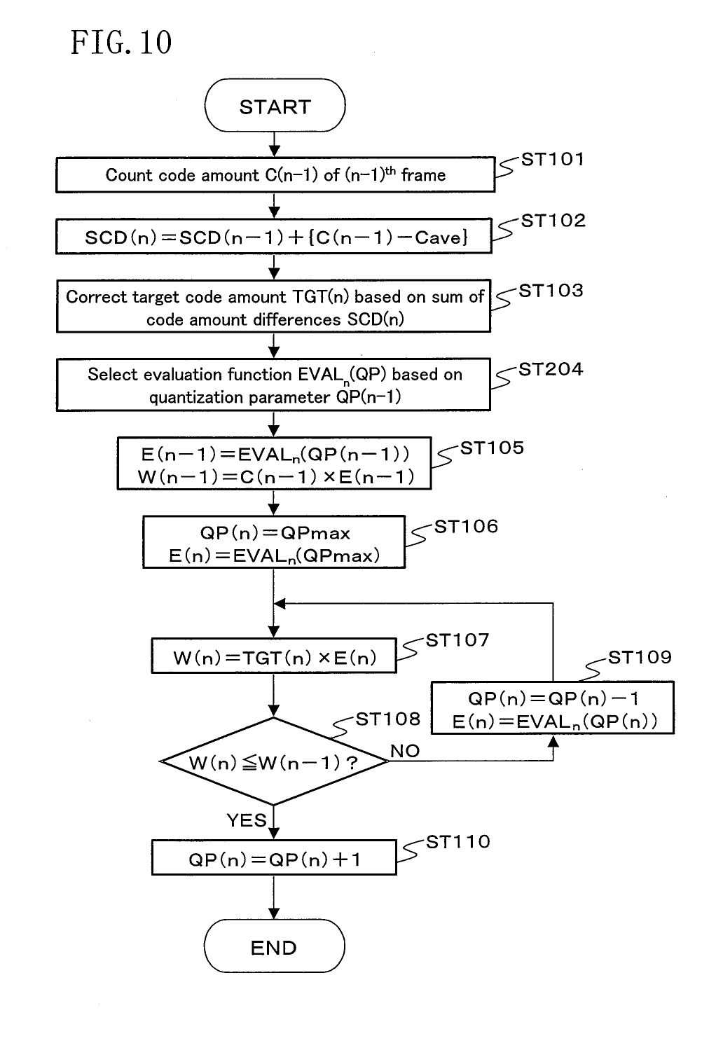

A video encoding device according to Embodiment 2 of the present invention is similar in configuration to that shown in FIGS. 1 and 2, but is different therefrom in terms of the operation by the evaluation function selecting section 205. Referring to FIG. 10, the evaluation function selecting section 205 selects the evaluation function EVALₙ for the n^{th} frame based not on the calculation of the motion vector by the motion detection/compensation section 101, but on the quantization parameter QP(n−1) for the (n−1)^{th} frame determined by the quantization parameter determination section 206 (step ST204). Otherwise, the process is as shown in FIG. 3.

For example, the external control circuit 12 sets a threshold value QPth of the quantization parameter in the evaluation function selecting section 205, and the evaluation function selecting section 205 compares the quantization parameter QP(n−1) for the (n−1) h frame and the threshold value QPth of the quantization parameter with each other. If the quantization parameter QP(n−1) is less than the threshold value QPth of the quantization parameter, the evaluation function selecting section 205 selects, as the evaluation function EVALₙ for the n^{th} frame, an evaluation function having a higher exponent than the evaluation function currently being selected (the evaluation function EVALₙ₋₁). If the quantization parameter QP(n−1) is greater than the threshold value QPth of the quantization parameter, the evaluation function selecting section 205 selects, as the evaluation function EVALn for the n^{th} frame, the evaluation function currently being selected (the evaluation function EVALₙ₋₁ for the (n−1)^{th} frame).

As described above, by evaluating the quantization parameter by using an evaluation function that is selected based on a previously-used quantization parameter, it is possible to reduce the influence of the code amount and to suppress the erroneous calculation of the quantization parameter. Thus, it is possible to appropriately calculate the quantization parameter based on a previously-used quantization parameter.

The evaluation function selecting operation based on the comparison between quantization parameters may be combined with the above-described evaluation function selecting operation based on the calculation of the motion vector.

### Camera System

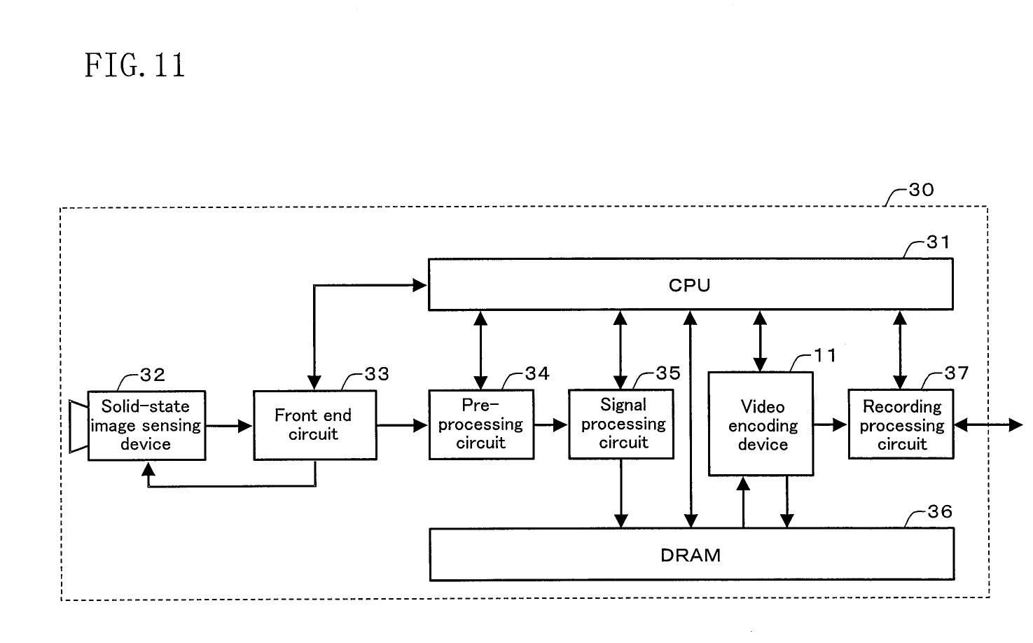

The video encoding device 11 of the present invention can be used in a camera system, as shown in FIG. 11. Referring to FIG. 11, a camera system 30 includes a CPU 31, a solid-state image sensing device 32, a front end circuit 33, a pre-processing circuit 34, a signal processing circuit 35, a DRAM 36, and a recording processing circuit 37, in addition to the video encoding device 11 shown in FIG. 1.

The solid-state image sensing device 32 is a CCD or a MOS sensor, and stores the input light information for each pixel in the form of an electric charge to thereby produce image data. The front end circuit 33 produces a control signal for the image sensing device based on the received sync signal. The front end circuit 33 performs correlated double sampling, gain adjustment, AD conversion, etc., on the image data produced by the solid-state image sensing device 32 to thereby produce digital image data. The pre-processing circuit 34 performs operations such as black level correction and defective pixel correction based on shaded pixel information, or the like, on the digital image data from the front end circuit 33. The signal processing circuit 35 performs a YC separation process on the digital image data, which has been processed by the pre-processing circuit 34, to thereby produce YC data (luminance (Y) data, color-difference (C) data). The DRAM 36 stores the YC data produced by the signal processing circuit 35. The video encoding device 11 encodes the YC data stored in the DRAM 36, as controlled by the CPU 31. The encoded YC data is stored in the DRAM 36. The recording processing circuit 37 subjects the encoded YC data stored in the DRAM 36 to operations required for the data to be recorded (e.g., header generation) and operations required for the data to be transmitted via a network. The CPU 31 writes data in the encoded YC data, which has been processed by the recording processing circuit 37. Moreover, the recording processing circuit 37 transfers the encoded YC data, in which data has been written by the CPU 31, to a storage medium.

### Network Camera

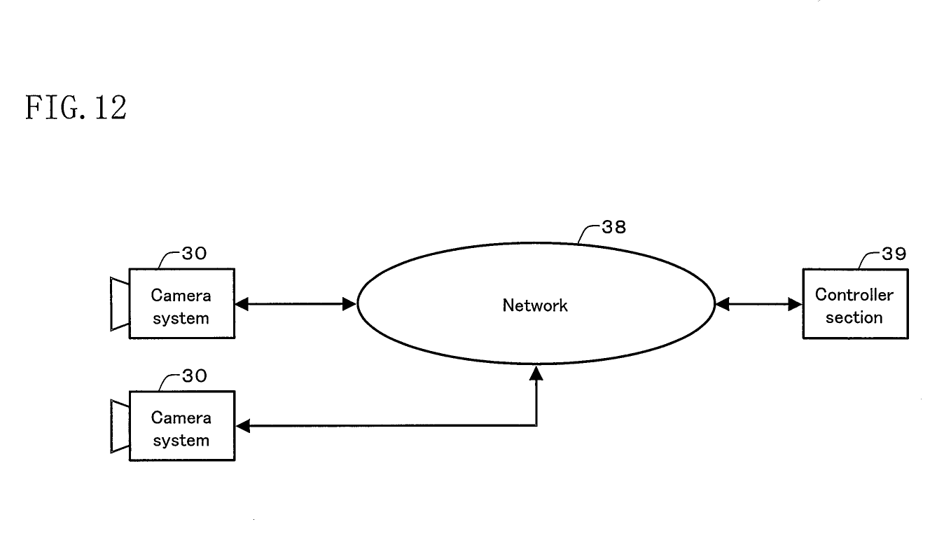

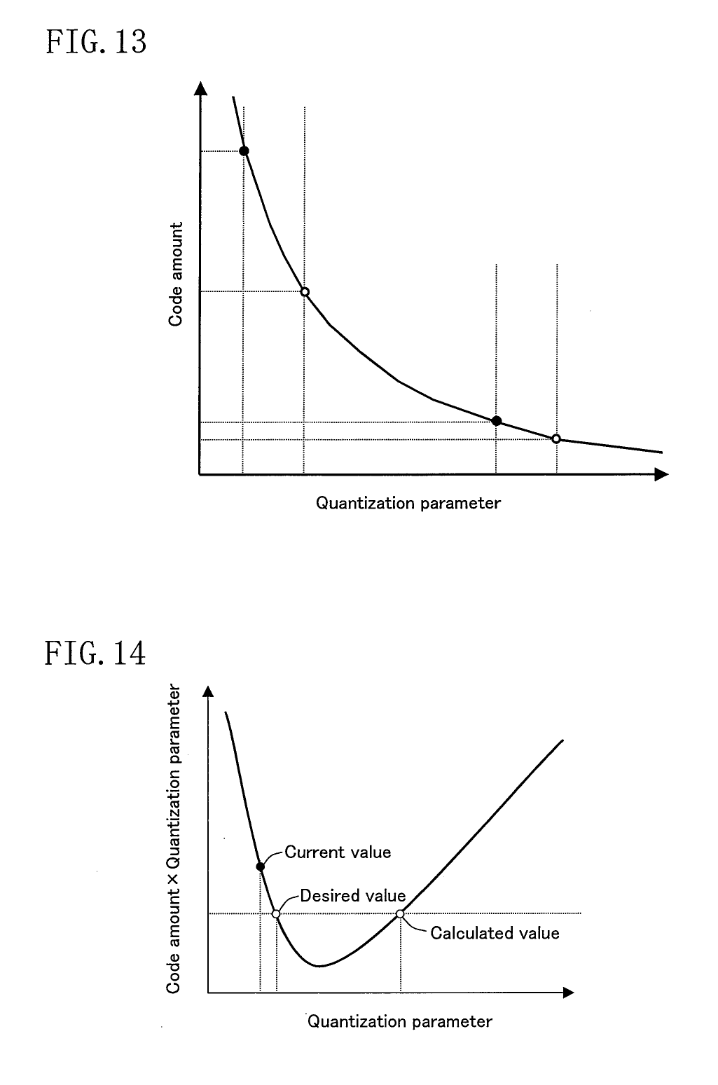

The camera system 30 shown in FIG. 11 may be used as a network camera, as shown in FIG. 12. In such a case, the recording processing circuit 37 included in the camera system 30 transmits the encoded YC data, in which data has been written by the CPU 31, to a network 38.

A controller section 39 transmits information necessary for setting the camera direction, the video quality, the bit rate, etc., to the camera systems 30, 30, . . . , via the network 38. In each of the camera systems 30, 30, . . . , the CPU 31 controls the motion detection/compensation section 101 and the code amount controlling section 109 included in the video encoding device 11 based on the information from the controller section 39.

### Other Embodiments

In each of the embodiments above, the code amount controlling section 109 may be included in the video encoding device 11, or may be provided outside the video encoding device 11.

Each of the functional blocks included in the video encoding device 11 can usually be realized by an MPU, a memory, or the like. The operation by each of the functional blocks can be realized by software (a program), which is recorded on a storage medium such as a ROM. The software may be distributed as downloadable software or as software recorded on a storage medium such as a CD-ROM. It is understood that each functional block data can be realized by hardware (a dedicated circuit).

The code amount controlling method and device of the present invention are applicable to a digital camera, a network camera, or the like, including a video encoding device therein.

What is claimed is:

1. A method for controlling an amount of code generated in a video encoding device, the video encoding device including:
a motion detection/compensation section for performing a motion detection/compensation operation on video data being whole or part of a video frame to thereby calculate a motion vector, and for outputting predictive data;
an orthogonal transformation section for performing an orthogonal transformation on a difference between the video data and the predictive data;
a quantization section for quantizing difference data, which has been transformed by the orthogonal transformation section, by using a quantization scale determined based on a quantization parameter; and
an encoding section for encoding the difference data quantized by the quantization section and the motion vector calculated by the motion detection/compensation section, the code amount controlling method comprising the steps of:
(a) counting an amount of code generated while first video data is encoded by the encoding section;
(b) adding a difference between the code amount counted in the step (a) and a predetermined code amount to a sum of code amount differences;
(c) correcting a target code amount for second video data to be encoded after the first video data, based on an accumulated sum calculated in the step (b);
(d) selecting an evaluation function for the second video data, from among a plurality of evaluation functions each representing a relationship between the quantization parameter and an evaluation value, based on the calculation of the motion vector of the second video data by the motion detection/compensation section; and
(e) calculating a first value based on a first quantization parameter for the first video data, the evaluation function selected in the step (d) and the code amount counted in the step (a), calculating a second value based on a second quantization parameter for the second video data, the evaluation function selected in the step (d) and the target code amount corrected in the step (c), and determining the second quantization parameter so that a difference between the first value and the second value is less than or equal to a predetermined amount.

2. The code amount controlling method of claim 1, wherein in the step (d), the evaluation function for the second video data is selected based on a sum of absolute differences calculated during the motion detection/compensation operation on the second video data.

3. The code amount controlling method of claim 2, wherein in the step (b), the evaluation function is changed when an average value of the sum of absolute differences is greater than a predetermined value, and the evaluation function is not changed when the average value of the sum of absolute differences is less than the predetermined value.

4. The code amount controlling method of claim 1, wherein in the step (d), the evaluation function for the second video data is selected based on a value represented by the motion vector calculated during the motion detection/compensation operation on the second video data.

5. The code amount controlling method of claim 4, wherein in the step (d), the evaluation function is changed when a value represented by the motion vector does not fall within a predetermined limit range, and the evaluation function is not changed when the value represented by the motion vector falls within the limit range.

6. The code amount controlling method of claim 1, wherein in the step (d), the evaluation function for the second video data is selected based on the number of motion vectors calculated during the motion detection/compensation operation on the second video data.

7. The code amount controlling method of claim 6, wherein in the step (d), the evaluation function is changed when the number of motion vectors is less than a predetermined number, and the evaluation function is not changed when the number of motion vectors is greater than the predetermined number.

8. The code amount controlling method of claim 1, wherein in the step (d), the evaluation function for the second video data is selected based on the calculation of the motion vector of the second video data by the motion detection/compensation section and the first quantization parameter for the first video data.

9. The code amount controlling method of claim 8, wherein in the step (d), the evaluation function is changed when the first quantization parameter is less than a predetermined value, and the evaluation function is not changed when the first quantization parameter is greater than the predetermined value.

10. A method for controlling an amount of code generated in a video encoding device, the video encoding device including:
a motion detection/compensation section for performing a motion detection/compensation operation on video data being whole or part of a video frame to thereby calculate a motion vector;
an orthogonal transformation section for performing an orthogonal transformation on the video data;
a quantization section for quantizing video data, which has been transformed by the orthogonal transformation section, by using a quantization scale determined based on a quantization parameter; and
an encoding section for encoding the video data quantized by the quantization section and the motion vector calculated by the motion detection/compensation section, the code amount controlling method comprising the steps of:
(a) counting an amount of code generated while first video data is encoded by the encoding section;
(b) adding a difference between the code amount counted in the step (a) and a predetermined code amount to a sum of code amount differences;
(c) correcting a target code amount for second video data to be encoded after the first video data, based on an accumulated sum calculated in the step (b);
(d) selecting an evaluation function for the second video data, from among a plurality of evaluation functions each representing a relationship between the quantization parameter and an evaluation value, based on a first quantization parameter for the first video data; and
(e) calculating a first value based on a first quantization parameter for the first video data, the evaluation function selected in the step (d) and the code amount counted in the step (a), calculating a second value based on a second quantization parameter for the second video data, the evaluation function selected in the step (d) and the target code amount corrected in the step (c), and determining the second quantization parameter so that a difference between the first value and the second value is less than or equal to a predetermined amount.

11. A device for controlling an amount of code generated in a video encoding device, the video encoding device including:
a motion detection/compensation section for performing a motion detection/compensation operation on video data being whole or part of a video frame to thereby calculate a motion vector;
an orthogonal transformation section for performing an orthogonal transformation on the video data;
a quantization section for quantizing video data, which has been transformed by the orthogonal transformation section, by using a quantization scale determined based on a quantization parameter; and
an encoding section for encoding the video data quantized by the quantization section and the motion vector calculated by the motion detection/compensation section, the code amount controlling device comprising:
a code amount counting section for counting an amount of code generated while video data is encoded by the encoding section, each time the encoding of the video data by the encoding section is completed;
an SCD calculation section for summing a difference between the code amount counted by the code amount counting section and a predetermined code amount;
a target code amount correction section for correcting a target code amount for video data to be encoded next, based on a sum of code amount differences calculated by the SCD calculation section;
an evaluation function selecting section for selecting an evaluation function for the video data, from among a plurality of evaluation functions each representing a relationship between the quantization parameter and an evaluation value, based on the calculation of the motion vector of the video data by the motion detection/compensation section; and
a quantization parameter determination section for determining a second quantization parameter so that a difference between a first value and a second value is less than or equal to a predetermined amount, wherein the first value is determined based on a quantization parameter for first video data, an evaluation function for second video data to be encoded after the first video data, and the code amount of the first video data, and the second value is determined based on a second quantization parameter for the second video data, the evaluation function for the second video data, and a target code amount for the second video data.

12. A device for controlling an amount of code generated in a video encoding device, the video encoding device including:
a motion detection/compensation section for performing a motion detection/compensation operation on video data being whole or part of a video frame to thereby calculate a motion vector;
an orthogonal transformation section for performing an orthogonal transformation on the video data;
a quantization section for quantizing video data, which has been transformed by the orthogonal transformation section, by using a quantization scale determined based on a quantization parameter; and
an encoding section for encoding the video data quantized by the quantization section and the motion vector calculated by the motion detection/compensation section, the code amount controlling device comprising:
a code amount counting section for counting an amount of code generated while video data is encoded by the encoding section, each time the encoding of the video data by the encoding section is completed;
an SCD calculation section for summing a difference between the code amount counted by the code amount counting section and a predetermined code amount;
a target code amount correction section for correcting a target code amount for video data to be encoded next, based on a sum of code amount differences calculated by the SCD calculation section;
an evaluation function selecting section for selecting an evaluation function for the video data, from among a plurality of evaluation functions each representing a relationship between the quantization parameter and an evaluation value, based on the quantization parameter, which has been used for determining the quantization scale used when the video data is quantized by the quantization section; and
a quantization parameter determination section for determining a second quantization parameter so that a difference between a first value and a second value is less than or equal to a predetermined amount, wherein the first value is determined based on a quantization parameter for first video data, an evaluation function for second video data to be encoded after the first video data, and the code amount of the first video data, and the second value is determined based on a second quantization parameter for the second video data, the evaluation function for the second video data, and a target code amount for the second video data.

13. A camera system, comprising:
an image sensing device for converting an image of an object into an electric signal;
a signal conversion circuit for converting the electric signal obtained by the image sensing device into image data;
a video encoding device for encoding the image data converted by the signal conversion circuit; and
the code amount controlling device of claim 11 for controlling an amount of code generated in the video encoding device.

14. A camera system, comprising:
an image sensing device for converting an image of an object into an electric signal;
a signal conversion circuit for converting the electric signal obtained by the image sensing device into image data;
a video encoding device for encoding the image data converted by the signal conversion circuit; and
the code amount controlling device of claim 12 for controlling an amount of code generated in the video encoding device.
